(19) United States
(12) Patent Application Publication
(10) Pub. No.: US 2002/0051545 A1
(43) Pub. Date: May 2, 2002

(54) Encryption multiplexing

(76) Inventor: John W.L. Ogilvie, Salt Lake City, UT (US)

Correspondence Address: JOHN W L OGILVIE, COMPUTER LAW, 1211 EAST YALE AVE, SALT LAKE CITY, UT, 84105, US

(21) Appl. No.: 09/909,120

(22) Filed: Jul. 19, 2001

Related U.S. Application Data
(60) Provisional application No. 60/225,383, filed on Aug. 14, 2000.

(51) Int. Cl. H04L 9/00

(52) U.S. Cl. 380/280

(57) ABSTRACT

The invention provides tools and techniques for enhancing the security of information by misdirecting unauthorized parties, so they believe they have decrypted a message and obtained protected information when in fact they have only obtained the plaintext the information's owners wanted them to obtain. Thus, the invention provides tools and techniques for using different decryption keys to surreptitiously provide different decryption results for what is apparently a single encrypted message. An encrypted mux message includes encryptions for several plaintexts, each of which has a corresponding key, and the decoding software displays plaintext according to which key is used.

### RELATED APPLICATIONS

This application claims priority to commonly owned copending application Ser. No. 60/225,383 filed Aug. 14, 2000, which is incorporated herein by reference.

### FIELD OF THE INVENTION

The present invention relates to data encryption, steganography, and key management, and in particular relates to the use of keys to select for decryption one or more different pieces of plaintext which are embedded in a message that appears to contain fewer pieces of plaintext than it actually contains.

### TECHNICAL BACKGROUND OF THE INVENTION

Conventionally, a given piece of plaintext (text, image, spreadsheet, program code, etc.) may be encrypted using a single symmetric encryption key (same key used to encrypt and decrypt) or a single asymmetric key (e.g., public key used to encrypt, private key needed to decrypt). A piece of plaintext may also be encrypted using several keys which are applied in succession, e.g., one may do a fast but less secure encryption with one key, and then do a slower but more secure encryption of the result using another key. In a digital certificate, different parts of the certificate may also be encrypted a different number of times and/or encrypted using different keys or algorithms.

However, a potential disadvantage of encryption is that an encrypted message is typically illegible, so it is easy to deduce that it is encrypted. It follows that the message apparently contains information worth encrypting, and that the information will be available if one can somehow obtain a decryption key. Thus, the mere presence of an encrypted message encourages active measures to obtain the encrypted information. This can be a serious problem for the encrypted message's owners and carriers, particularly if the active measures involve tortious and/or criminal activities.

Conventionally, steganography may be used to encode a message in an unobtrusive manner, by subtly altering spacing in a text document, for instance, or by subtly altering pixels in an image. Watermarks may be placed in documents using steganographic procedures. This has the advantage of making encrypted messages available in an unobtrusive manner, so that presence of the encrypted message may be undetected. Thus, the use of active measures to obtain a key might be delayed or avoided if the message is hidden by steganographic means.

Although a distinction may be made between encoding a message through encryption and encoding it through steganography, each approach requires a key to obtain a legible (plaintext) version of the encoded information. For convenience, any key used to decode encoded information is called herein a decryption key.

To the inventor's knowledge, conventional steganography and encryption do not specifically and fully address situations in which an unauthorized party expects to find an encrypted message and the authorized party wishes nonetheless to securely preserve and/or convey encrypted information. The conventional approaches to increasing security have been directed primarily at providing stronger forms of encryption (so that brute force attacks without a key take more computation than before to decode the encrypted information) and providing better key management tools and procedures (such as public key certification authority hierarchies). Using conventional steganographic techniques to hide the encrypted information in plain sight does not provide the desired result in some situations because the unauthorized party will keep looking until encoded information is found.

FIG. 1 illustrates generally the principal steps and items involved in attacks on conventional encrypted messages. An unauthorized party expects 100 an authorized party to use an encrypted message. The unauthorized party wants access to a decrypted (plaintext) copy of information from the message, and toward that end employs active measures which are not necessarily legal or ethical. To obtain the desired plaintext 114, the unauthorized party needs to obtain 102 a copy of the encrypted message and a key 110 to decrypt 112 that message. The encrypted message copy may be obtained before the key is obtained, or vice versa, as indicated by following alternate paths in FIG. 1.

For instance, after obtaining 102 a copy of the encrypted message 104, the unauthorized party may use it to obtain a key through computational decryption attacks 106 on the message 104. Or the unauthorized party may obtain a key through theft, duress, deception, extortion, or other reprehensible activities 108. As indicated, such active measures 108 may also be used to obtain a key before a copy of the encrypted message 104 is obtained 102. Regardless, once the unauthorized party has obtained both a key 110 and a copy of the encrypted message 104, the unauthorized party may obtain the desired plaintext 114 by decrypting 112 the message using the key with standard or proprietary software.

As noted, in such scenarios conventional approaches may reduce the risk that the unauthorized party will obtain the desired plaintext 114 include, e.g., one may strengthen the encryption algorithm to make brute force computational attacks 106 more difficult, and/or improve key management tools and procedures to reduce or eliminate loss of keys due to carelessness or casual theft. Physical security measures and surveillance techniques may also be used to protect keys, copies of encrypted information, or both.

But misdirection of unauthorized parties has not, to the inventor's knowledge, been systematically employed to reduce the damage caused by unauthorized parties who take active measures against encoded information. Thus, it would be an advancement to provide new tools and techniques for misdirecting or misinforming unauthorized persons so that their improper activities fail to reveal critical encoded information, or at least do so later than would otherwise occur. Such tools and techniques are described and claimed herein.

### BRIEF SUMMARY OF THE INVENTION

The invention provides tools and techniques for enhancing the security of information by misdirecting unauthorized parties, so they will believe they have decrypted a message and obtained protected information when in fact they have only obtained the plaintext the information's rightful owners or guardians wanted them to obtain. This is accomplished by providing different decryption results (namely, different plaintext) for different keys based on what is apparently a single encryption of a single plaintext.

A method of the invention, for instance, gathers at least two plaintext messages, and creates from them an encrypted mux message (“mux” refers to “multiplexed”). The encrypted mux message comprises encryptions of the plaintext messages but is disguised to resemble an encryption of a single plaintext message. For instance, the encrypted mux message may have one or more of the following characteristics in common with an encryption of a single plaintext message: syntax, file name, file name extension, creation date, modification date, length, header, checksum, digital signature, storage directory. An authorized party chooses which of the plaintext messages will be revealed. The key for the chosen message is then made available to an unauthorized party, which permits the unauthorized party to obtain the information in the chosen plaintext message by decrypting a portion of the encrypted mux message. However, the unauthorized party does not decrypt another portion of the encrypted mux message, and generally does not even recognize the existence of that other portion. Risk to the alternate plaintext is thus reduced.

An inventive method for use in a software program to enhance the security of information comprises the steps of: accepting a key from a user; using the key to find a corresponding message encryption in a file containing encryptions of at least two plaintext messages; decrypting the corresponding message encryption; and making plaintext available to the user. A field in the key may be used to find the corresponding message encryption in the muxed file, by specifying a label, for instance, or by providing a string or other pattern to be matched in the desired plaintext. Plaintext may be made available to the user by displaying it on a computer screen, saving a copy of the plaintext in a file accessible to the user, and/or transmitting a copy of the plaintext over a network to a destination specified by the user. The plaintext may be watermarked to track key usage. Usage of a key may also cause a silent alert if the use is potentially or actually unauthorized.

The encrypted mux message may be embodied in RAM, hard disks, other nonvolatile storage media, network links, and other computer-readable media. The embodied encrypted mux message is susceptible of being at least partially decrypted in response to provision of a key corresponding to an encryption of plaintext within the encrypted mux message, as noted above. Internally, the structure of the mux message may comprise contiguously stored message encryptions or interleaved stored message encryptions. The encrypted mux message may contain message selection hints, such as labels, to aid an authorized user in specifying the plaintext to be provided by the decryption software. General-purpose computer systems may also be configured with software and data to operate specifically as discussed herein; similarly configured special-purpose computer hardware may also be made and/or used according to the invention. Other aspects and advantages of the present invention will become more fully apparent through the following description.

### BRIEF DESCRIPTION OF THE DRAWINGS

To illustrate the manner in which the advantages and features of the invention are obtained, a more particular description of the invention will be given with reference to the attached drawings. These drawings only illustrate selected aspects of the invention and thus do not determine the invention's scope. In the drawings:

FIG. 1 shows a data flow diagram illustrating attacks on conventional encrypted messages.

FIG. 2 shows a data flow diagram illustrating use of a novel encrypted multiplexed message to provide an unauthorized party with plaintext selected by an authorized party, thereby misdirecting the unauthorized party and reducing the risk of further attacks on unrevealed portions of the multiplexed message.

FIG. 3 shows the internal structure of some embodiments of a multiplexed message according to the present invention, in which an encryption of a given plaintext message is stored contiguously, and is concatenated with contiguous encryptions of one or more other plaintext messages to form the multiplexed message.

FIG. 4 shows the internal structure of other embodiments of a multiplexed message of the invention, in which portions of encryptions of two or more plaintext message are interleaved to form the multiplexed message.

FIG. 5 shows the internal structure of other embodiments of multiplexed messages according to the present invention, in which labels are embedded as selection hints to facilitate selection of a desired plaintext message by an authorized party.

FIG. 6 illustrates a method of the present invention for creating and making available selected keys.

FIG. 7 illustrates a method for use in decryption software according to the present invention.

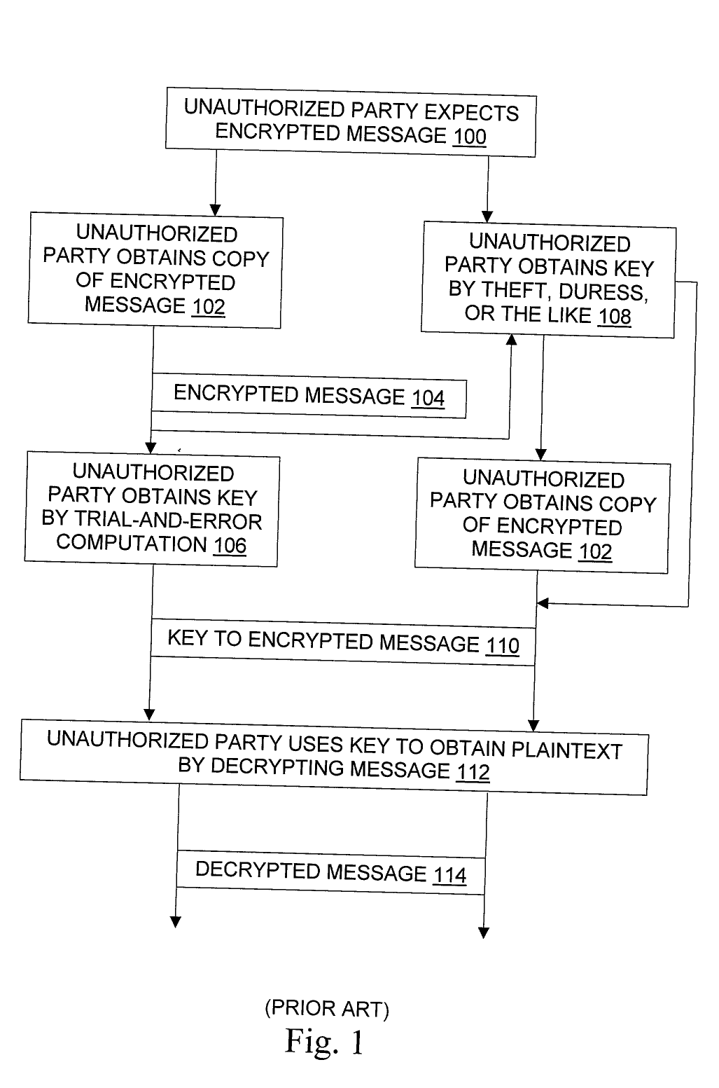

### DETAILED DESCRIPTION OF THE PREFERRED EMBODIMENTS

In describing methods, devices, signals, programs, products, and systems according to the invention, the meaning of several important terms is clarified, so the claims must be read with careful attention to these clarifications. Specific examples are given to illustrate aspects of the invention, but those of skill in the relevant art(s) will understand that other examples may also fall within the meaning of the terms used, and hence within the scope of one or more claims. Important terms may be defined, either explicitly or implicitly, here in the Detailed Description and/or elsewhere in the application file. In particular, an “embodiment” of the invention may be a system, an article of manufacture, a method, and/or a signal which configures a computer memory or other digital or analog medium. Also, a given party may be “authorized” for some activities and “unauthorized” for others.

The present invention permits semantically selective decryption by associating two or more passwords/pass phrases/keys/tokens/etc. (“keys”) with two or more corresponding pieces of plaintext in a single file or a package that otherwise appears—at least at first glance—to contain only a single piece of plaintext. Such a file or package is called an “encrypted mux message” or “muxed message”, for instance. By unobtrusively choosing between the decryption keys, a person who is privy to the presence of two or more plaintexts in the encrypted mux message can choose between alternate plaintexts, while apparently simply supplying “the” (apparently unique) key needed to decrypt “the” (apparently entire) message.

Also, someone who is authorized and knows about the multiplexing may unobtrusively permit “the” key to be discovered so that the security of “the” message is apparently compromised, while actually conveying another key to the intended message to a desired recipient in a secure manner. The authorized message sender can thus misdirect unauthorized interceptors by giving them what is apparently cleverly gained access to a first plaintext, while the desired message is actually in a second plaintext in the same file.

The invention can also be used to securely and cost-effectively provide different plaintext messages to different parties (authorized and/or unauthorized) while distributing only a single identical (or substantively identical) muxed message to all of the parties. Each party will receive the plaintext it should receive if each party receives the key corresponding to that plaintext.

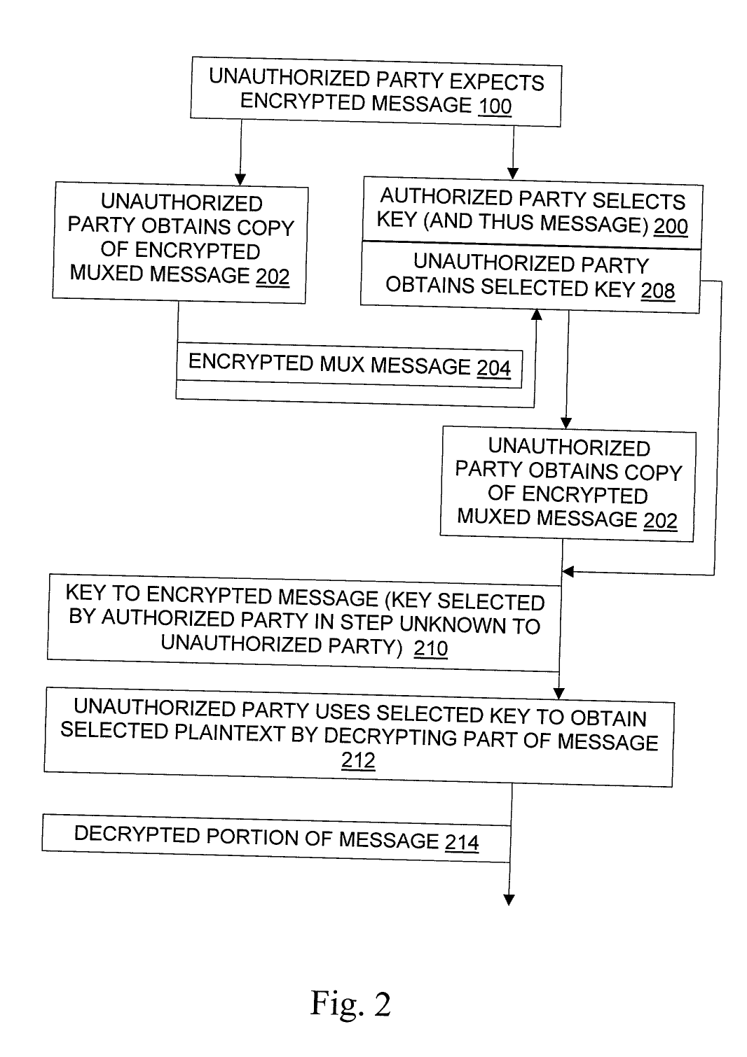

Uses of encrypted mux messages are further illustrated in FIG. 2. An unauthorized party expects 100 an authorized party to use an encrypted message. The unauthorized party wants access to a decrypted (plaintext) copy of information from the message, and toward that end employs active measures which are not necessarily legal or ethical. To obtain the desired plaintext, the unauthorized party needs to obtain 202 a copy of the encrypted message, a key corresponding to that message, and software which can use the key to decrypt the message. The decryption software may be configured to recognize internally that multiple messages are present, but it preferably does not prominently advertise that ability and it most preferably does not inform users that multiple messages are present when decrypting a muxed message 204 that apparently contains only one message. An unauthorized party who does not know that the muxed message 204 contains more plaintext than the software is revealing will be satisfied that the necessary key(s) are in hand once a single plaintext is extracted from the message 202. More generally, if the unauthorized party believes that the message 204 contains fewer plaintexts than are actually present, one or more plaintexts may remain hidden after the unauthorized party believes (erroneously) that all plaintext has been extracted from the message 202.

Before or after obtaining 202 a copy of the encrypted message 204, the unauthorized party obtains 208 a key. However, the unauthorized party does not know that the key obtained 208 has been selected 200 by an authorized party to misdirect the unauthorized party. Selecting 200 the key 210 determines which plaintext message 214 can be extracted 212 from the encrypted mux message 204 with the key. More generally, a given piece of plaintext may be encrypted with multiple keys (an encrypted text may be input to an encryption process). Thus, selecting 200 the keys 210 determines which plaintext message 214 can be extracted 212 from the encrypted mux message 204 with those keys. Conventional tools and techniques may be used in combination with encrypted mux messages 204 and key selection 200, for added security and/or or to strengthen the credibility of the perceived encryption protection, thereby improving the likelihood that the misdirection will succeed by delaying or preventing the unauthorized party from obtaining plaintext for which keys were not selected 200.

As a simple example, a file which is apparently of the kind that conventionally contains a single plaintext message encrypted by a single key may instead contain three encrypted messages, each with its own corresponding decryption key, as follows:

| key | plaintext |
|---|---|
| A1a | “The offer is accepted” |
| B2b | “The merchandise has not arrived” |
| C2c | “The price is too low” |

The muxed file 204 may be disguised as a conventional encrypted file 104 by virtue of having the expected syntax, file name, file name extension, date(s), length, header, checksum, digital signature, storage directory, and/or other characteristics of conventional files 104. Compression or padding may be used to provide the muxed file 204 with a length that is appropriate for a conventional encrypted file 104. To avoid raising suspicions, hidden messages in a muxed file 204 are preferably shorter than revealed messages so that the length of the revealed message corresponds generally to the length of the entire encrypted muxed message. The same and/or different encryption algorithms (including steganographic techniques in some embodiments) may be used for the different messages in the file 204.

An authorized party who is being forced 208 to help decrypt the file 204 could gain time by entering 200 key B2b into the decryption software. That person could enter the intended key A1a at some other time, when duress is not being applied, to thereby learn the “true”, i.e., intended message.

Moreover, someone who is suspected of being a security threat could be given 200 the third key, in what appears to be the normal course of business but is actually a security test, to see whether opposition steps indicating unauthorized decryption 212 are then taken in response to the third message 214. If such steps are taken, that may confirm that the suspect is indeed violating security.

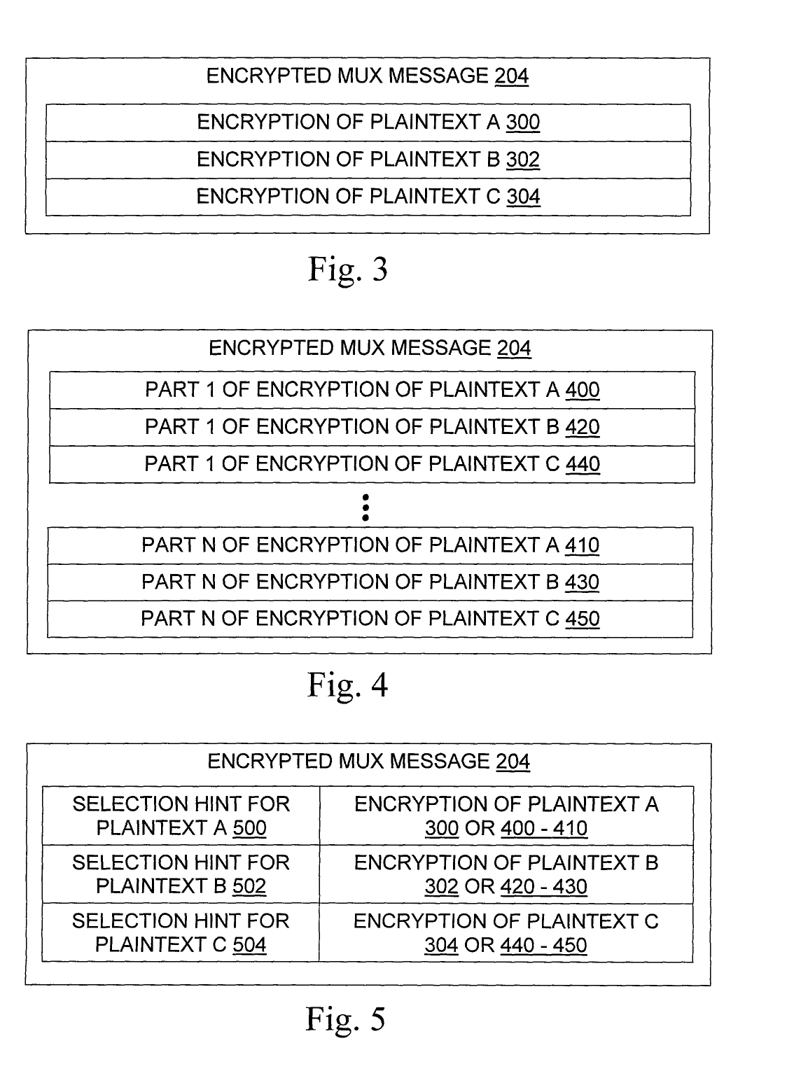

FIGS. 3 to 5 illustrate some of the possible structures that may be used to organize plaintext encryptions inside a file or other muxed message 204 implementation. Other structures may also be used according to the claimed methods, and may be equivalent to the illustrated structures. Although three messages (A, B, C) are shown in the Figures, a given muxed message 204 according to the invention may contain encryptions of two or more separate plaintext messages 214.

As shown in FIG. 3, the different messages 300, 302, 304 in a muxed message file 204 may be placed in succession, so that a given key 210 starts decryption at a corresponding offset into the file. Padding may be used to place the start of the next message at the desired offset. Marker or signature bytes may be used to identify the start of subsequent messages 302, 304 to a decryption module instead of relying on fixed offsets, e.g., each encryption of a message 300, 302, 304 may begin with the hex value CODE. A jump table in a header of the muxed filed 204 could also specify the offsets of the muxed file's two or more encryptions. To reduce the risk of detection and improper use, the jump table entries may be byte-wise or entry-wise interleaved with each other or with irrelevant data, byte-reversed, or otherwise disguised, rather than being a straight-forward list of increasing numeric values.

As shown in FIG. 4, the message encryptions may also be interleaved, so that every third byte (or, more generally, every third run of N bytes) in a file of three messages corresponds to the third message, for instance. In the illustrated example, all three messages run to N parts; this may be done by padding shorter messages. Alternately, a header (not shown) in the muxed message 204 could specify for each distinct message (A, B, C) the number of parts into which that message is separated, or similar information, so that authorized decoding software can determine which parts belong to which message within the muxed message 204.

As shown in FIG. 5, muxed messages may include selection hints 500, 502, 504 to help an authorized party select 200 the correct message's key(s). These hints may be alphanumeric labels. In the preceding example, the following hints might be associated with corresponding messages in a muxed message file 204:

| key-root | hint | plaintext |
|---|---|---|
| x17 | A | “The offer is accepted” |
| x17 | W | “The merchandise has not arrived” |
| x17 | L | “The price is too low” |

As mnemonics, hint “A” stands for “accepted”, “W” stands for “waiting”, and “L” stands for “low”. Multi-character hints may be used in other cases. Each key is formed in this example by appending the hint to a key-root, e.g., the key 210 to decrypt 212 the first message is x17A. Thus, a key 210 may be formed by concatenating a conventional decryption key with a selection hint that specifies which plaintext message in the muxed encrypted message 204 should be decoded.

More generally, a key 210 may contain fields that specify in an authorized-user-friendly manner which message 214 the key reveals. As further examples, a “1” appended or prepended could mean the decoding software should decode the first message 300; an “a” anywhere in the key could instruct the software to decode the message that starts with “a” in its plaintext (which may actually involve decoding two or more messages until such a message 214 is found but displaying only that selected 200 message); and a “fox” in the key could mean the software should decode and display only the message that contains “fox” somewhere in its plaintext.

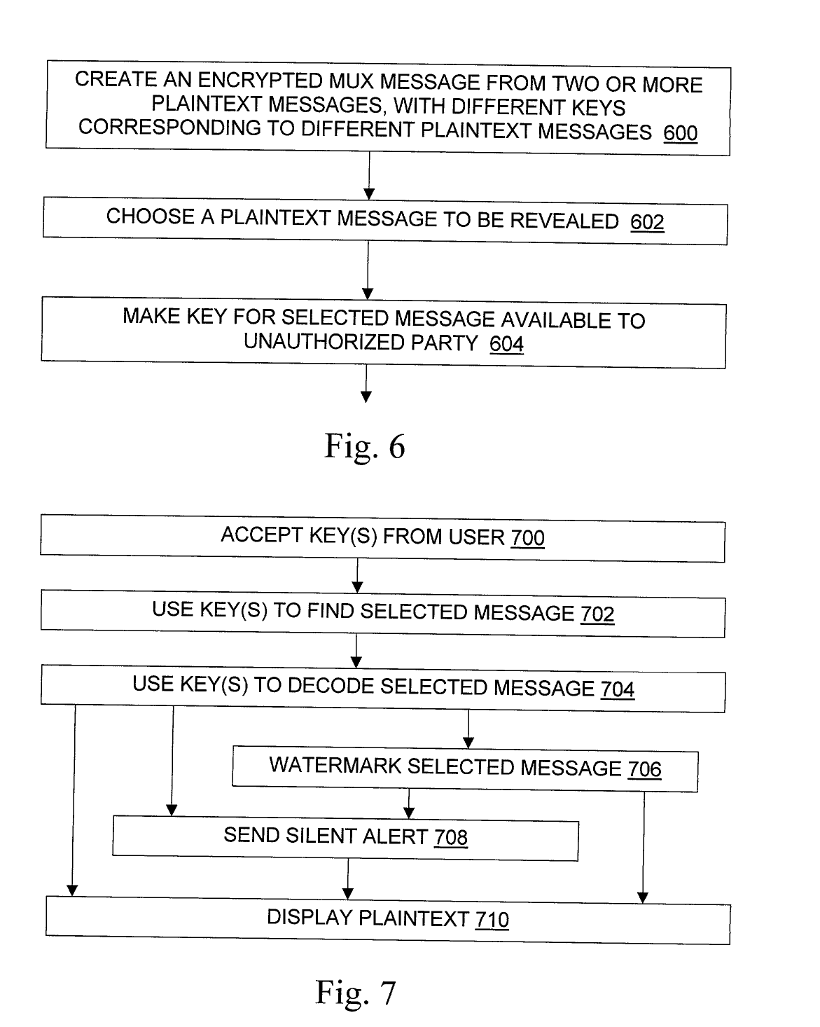

Methods of the invention are further illustrated in FIGS. 6 and 7. As shown in FIG. 6, an authorized party uses software to create 600 a muxed message 204 such as one discussed above. When subjected to duress, or as part of a security test as discussed above, the same authorized party or another authorized party chooses 602 one or more plaintext messages to be revealed. One or more key(s) for the chosen message(s) are made available 604 to one or more unauthorized parties, by acts such as feigned compliance under duress or feigned carelessness in key management. The unauthorized parties use 212 the provided key(s) to obtain the plaintext, in the mistaken belief that they have thereby obtained information the authorized parties wanted to keep hidden.

As shown in FIG. 7, decryption software preferably operates according to the discussion herein. The software accepts 700 one or more keys from a user, who may be authorized and acting in a routine scenario, may be authorized but acting under duress, or may even be an unauthorized user. A key may be entered by typing, file reading, voice analysis, card reading, or other familiar data entry means. The software then uses 702 the key to find the corresponding selected message, by table lookup, by string or other pattern matching based on a filed of the key, by using an offset calculation, or by other means. The key decodes 704 the selected message using decryption and/or steganographic algorithms and data structures. Ultimately, the software “displays” 710 the decoded plaintext; displaying may include copying the plaintext to a file or transmitting it over a network in addition to (or in place of) showing it on a computer monitor.

A decryption module may take additional actions according to the key 210 used. For instance, if a given decoy key is used, in addition to displaying 710 the corresponding decoy plaintext the module may surreptitiously (without informing the user) send 708 an email, pager, or other alert to the message originator. In one alternate embodiment, different keys produce identical plaintext results but extra action such as sending 708 an email alert is taken when a particular key is used. In one alternate embodiment, different keys produce what is apparently identical plaintext results, but at least one plaintext is surreptitiously watermarked 706 to permit identification of the key used, and hence the person who presumably supplied the key, by examination of the plaintext. The watermark content may be entirely predefined, or it may include information about the local environment in which decryption occurred, such as the computer's IP address or processor ID.

Suitable software to assist in implementing the invention is readily provided by those of skill in the pertinent art(s) using the teachings presented here and programming languages and tools such as C++, C, Java, APIs, SDKs, assembly, firmware, microcode, and/or other languages and tools.

Although particular embodiments of the present invention are expressly illustrated and described individually herein, it will be appreciated that discussion of one type of embodiment also generally extends to other embodiment types. For instance, the description of the methods illustrated in FIGS. 2, 6 and 7 also helps describe the systems and devices in FIGS. 3 through 5, and vice versa. All claims as filed are part of the specification and thus help describe the invention, and repeated claim language may be inserted outside the claims as needed.

As used herein, terms such as “a” and “the” and designations such as “key” and “party”, are inclusive of one or more of the indicated element. In particular, in the claims a reference to an element generally means at least one such element is required.

The invention may be embodied in other specific forms without departing from its essential characteristics. The described embodiments are to be considered in all respects only as illustrative and not restrictive. Headings are for convenience only. The scope of the invention is, therefore, indicated by the appended claims rather than by the foregoing description. All changes which come within the meaning and range of equivalency of the claims are to be embraced within their scope.

What is claimed and desired to be secured by patent is:

1. A method for enhancing the security of information, comprising the steps of:
gathering at least two plaintext messages, each plaintext message containing information; and
creating an encrypted mux message from the at least two plaintext messages, such that the encrypted mux message comprises encryptions of the at least two plaintext messages and the encrypted mux message has characteristics which disguise the encrypted mux message as an encryption of fewer plaintext messages than it actually contains.

2. The method of claim 1, wherein the creating step creates an encrypted mux message which has at least four of the following characteristics in common with an encryption of a single plaintext message: syntax, file name, file name extension, creation date, modification date, length, header, checksum, digital signature, storage directory.

3. The method of claim 1, wherein the creating step creates an encrypted mux message which has at least three of the following characteristics in common with an encryption of a single plaintext message: syntax, file name, file name extension, length, header, checksum, digital signature, storage directory.

4. The method of claim 1, further comprising the step of choosing a plaintext message to be revealed, the chosen plaintext message having an encryption in the encrypted mux message.

5. The method of claim 4, further comprising the step of making available to an unauthorized party a key for the chosen plaintext message, thereby permitting the unauthorized party to obtain the information in the chosen plaintext message by decrypting a portion of the encrypted mux message without permitting the unauthorized party to decrypt another portion of the encrypted mux message.

6. A method for use in a software program to enhance the security of information, comprising the steps of:
accepting a key from a user;
using the key to find a corresponding message encryption in a file containing encryptions of at least two plaintext messages, the file being disguised to resemble a file containing fewer encryptions than are actually present in the file;
decrypting the corresponding message encryption; and
making plaintext available to the user.

7. The method of claim 6, wherein the step of using the key to find a corresponding message encryption uses a field in the key to find the corresponding message encryption.

8. The method of step 7, wherein the field specifies a label located in the file to identify the corresponding message encryption.

9. The method of step 7, wherein the field specifies a string in the plaintext of the corresponding message encryption.

10. The method of step 6, wherein the step of making plaintext available to the user comprises at least one of the following: displaying the plaintext on a computer screen, saving a copy of the plaintext in a file, transmitting a copy of the plaintext over a network.

11. The method of step 6, wherein the step of making plaintext available to the user makes available the plaintext for the message encryption corresponding to the key provided.

12. The method of step 6, wherein the step of making plaintext available to the user makes available a watermarked version of the plaintext for the message encryption corresponding to the key provided.

13. The method of step 6, further comprising the step of sending a silent alert.

14. An article comprising a computer-readable medium configured with an embodied encrypted mux message that is disguised to hide at least one encryption and that is also susceptible of being at least partially decrypted in response to provision of a key corresponding to an encryption of plaintext within the encrypted mux message.

15. The article of claim 14, wherein the encrypted mux message is structured to contain contiguously stored message encryptions.

16. The article of claim 14, wherein the encrypted mux message is structured to contain interleaved stored message encryptions.

17. The article of claim 14, wherein the encrypted mux message contains message selection hints.

18. A computer system comprising a storage medium configured by an encrypted mux message stored therein, and a software security enhancing means for enhancing the security of information by using the encrypted mux message.

19. The system of claim 18, wherein the security enhancing means comprises software for creating an encrypted mux message from at least two plaintext messages.

20. The system of claim 18, wherein the security enhancing means comprises software for accepting a key from a user; using the key to find a corresponding message encryption in the encrypted mux message; decrypting the corresponding message encryption; and making plaintext available to the user.
